(19) United States
(12) Patent Application Publication
(10) Pub. No.: US 2001/0007378 A1
(43) Pub. Date: Jul. 12, 2001

(54) SURFACE LINING SYSTEM FOR PLASTIC PARTS

(76) Inventors: WILLIAM D. EWING, TIVERTON, RI (US); THOMAS P. HAMBLETON, NEHANT, MA (US)

Correspondence Address: LARSON & TAYLOR, PLC, 1199 NORTH FAIRFAX STREET, SUITE 900, ALEXANDRIA, VA, 22314, US

(21) Appl. No.: 08/818,196

(22) Filed: Mar. 14, 1997

(51) Int. Cl. B29C 45/14; B32B 1/02; B65D 51/00

(52) U.S. Cl. 264/266; 264/132; 264/247; 428/35.7; 220/200

(57) ABSTRACT

A surface lining system wherein an ultra low density polyethylene film is used as a lining material for cups, containers, caps and other plastic parts, the film having the property to elongate in a substantially uniform fashion in all directions at the same time and in relatively the same proportion.

### FIELD OF THE INVENTION

The present invention relates to a surface lining system, particularly a system that facilitates the lining or covering of a surface or surfaces of a thermoplastic part during the forming process of that part, “in-situ”.

### BACKGROUND OF THE INVENTION

The present known systems for providing specific surface characteristics to molded plastic objects include various known methods such as cathode sputtering, application of chemical and/or metal surface coverings, among other things. The industry thus would benefit from an improved surface lining system for plastic parts in which various pre-engineered advantages could be provided to the surface.

### SUMMARY OF THE INVENTION

An object of the present invention is to provide an improved surface lining system which uses the distortional and comformal properties of an engineered polymer liner film.

Another object of the present invention is to provide an improved surface lining system wherein an ultra low density polyethylene film is used as a lining material and it has properties which permit it to elongate in a substantially uniform fashion in all directions at the same time and in relatively substantially the same proportion.

A further object of the present invention is to provide a surface lining system which uses the properties of the liner film as a good receptor for various barrier materials such as Nylons PVDC, PET or EVOH as well as inks and other coatings that may be applied to the liner film by conventional methods.

Still a further object of the present invention is to provide an improved surface lining system wherein the engineered film becomes one of the surfaces of a plastic part and it brings with it the physical properties that have been imparted to the film.

Another object of the present invention is to provide a package which has a high percentage of material with recycled content while at the same time complying with regulations prohibiting food contact with recycled material.

Other objects and advantages of the present invention will become apparent from the following detailed description.

The present invention involves a surface lining system for plastic parts which facilitates the lining or covering of a surface or surfaces of a thermoplastic part during the forming process of the plastic part and “in-situ”. The lining or covering of a plastic part surface is useful and advantageous in that it provides an opportunity to add to the plastic part additional physical properties and other useful features. The present invention is very efficient in lining or covering of plastic parts because the designated surface of the plastic part may be lined or covered at the same time and in the same operation (e.g. injection molding) as the part is formed.

### BRIEF DESCRIPTION OF THE DRAWINGS

Other features and advantages of the present invention will be apparent from the following description taken in conjunction with the accompanying drawings wherein:

FIG. 1 is a schematic drawing of one embodiment of the present invention wherein a film is inserted between the parts of an open mold.

FIG. 2 shows one embodiment of the present invention after the mold is closed and thermoplastic is injected into the mold cavity.

FIG. 3 is a schematic drawing of another embodiment of the present invention wherein a plastic part with a viewing opening is formed.

FIG. 4 is a view of a container cap with a window opening according to one embodiment of the present invention.

FIG. 5 is a cross section of FIG. 4 along line 5-5.

### DETAILED DESCRIPTION OF PREFERRED EMBODIMENTS

The surface lining system according to the present invention is advantageous in that it is a hybrid system in which one layer or more of an engineered plastic film is brought into the molding process for the plastic part being lined and, due to the distortional and adhesional properties of the engineered film, it becomes at least part of one or more of the surfaces of the plastic part being molded.

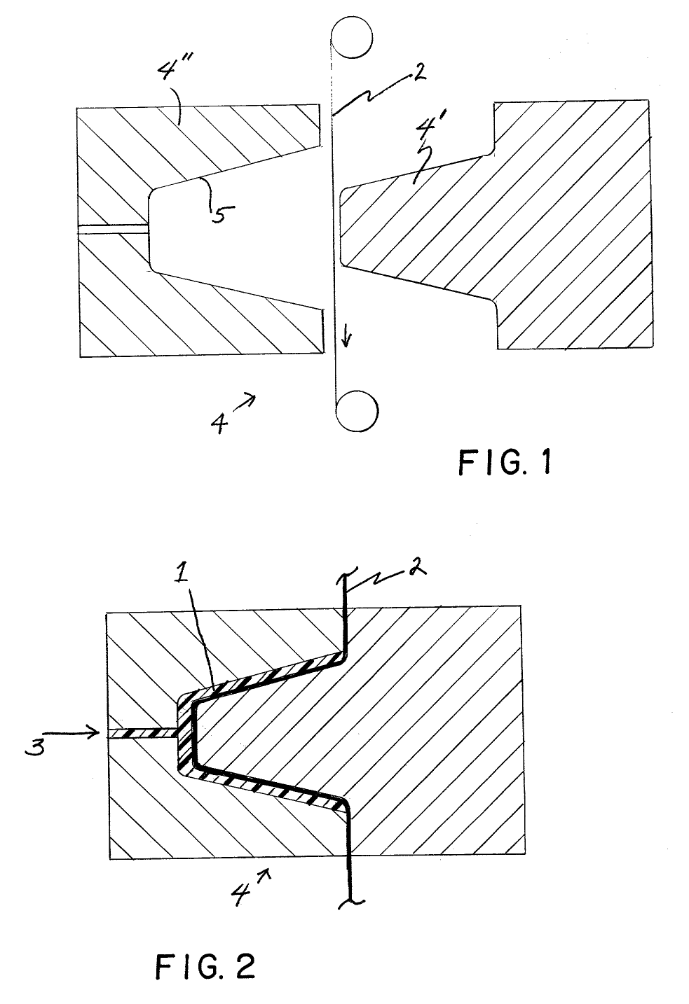

According to the present invention, to make a lined injection molded plastic part 1, the method of combining the two layers involves the insertion of the inner layer of engineered film 2 into the mold 4 before injecting the thermoplastic material 3 forming the outer layer. As shown in FIG. 1, a web of film for forming the liner film is drawn across the open mold 4 and is forced into the cavity 5 of the mold as the mold is closed prior to the injection of the thermoplastic material 3 to form the molded plastic part. As shown in FIG. 2, the injection of the thermoplastic material 3 into the mold cavity forms the outer wall of the part and forms a bond with the engineered film 2 as well as cutting the film to shape at the edge of the mold cavity.

According to the present invention, the molded plastic part 1, after being combined with the film layer 2, is ejected from the mold when the mold opens by conventional mechanisms and the web of film for forming the liner is advanced for the next injection molding cycle.

According to the present invention, to create a lined thermoformed plastic part, both the liner film and the plastic material to be formed are fed into the thermoformer at the same time. The liner film is adhered to the base plastic material and formed to the same shape in the forming process. The finished lined part is cut and delivered as one integral piece in the normal fashion and both the web of liner film and the base material advance for the next cycle.

According to the present invention, the surface lining of a blow-molded or compression-molded part is done in the same fashion as the injection molded plastic part.

One important aspect of the surface lining system of the present invention is the distortional and conformal properties of the engineered liner film. The ultra-low density polyethylene that is the current foundation of the lining material has the characteristic that it elongates in a uniform fashion in all directions at the same time and in relatively the same proportion. This means that when an object, such as a projection of a mold, is pressed into a secured web of this film and the film yields and elongates proportionally in all directions to line or cover the surface of the object being pressed into it. This characteristic of the lining material facilitates pre-distortional printing or decorating and pre-engineering of specific areas of the formed part. In addition to its distortional and conformal properties, the liner film of the present invention is a good receptor for various barrier materials such as PVDC or EVOH as well as inks and other coatings that may be applied to it by conventional methods. When the engineered film becomes one of the surfaces of a plastic part it brings with it the properties as well as the decorations that have been imparted to it. It should be understood that the pre-distortion printing or decorating would have a different configuration than the final format and shape of the decoration after the liner film has been distorted during elongation.

An example of a part lined in the forming process according to the present invention is a polyethylene plastic cup molded from a recycled polyethylene material that is not approved for direct food contact but is lined according to the present invention with a virgin FDA-approved film during a molding process so that the food contents of the plastic cup would not come in contact with the recycled plastic material used for the basic plastic cup. According to the present invention, a high density polyethylene plastic cup approximately 4 inches long and 2 inches in diameter was lined with an ultra low density polyethylene liner film of about 3 miles in thickness and identified by the trademark “Nucrel”® of E.I DuPont DeNemours and Co. and generically being described as an ultra low density polyethylene. Another such useful film is “Attane”® from The Dow Chemical Co. The mold plastic cup may be formed of polyethylene, polystyrene, polypropylene or polyethylene terpthalate.

Another example of the present invention is a plastic cap of a soda bottle which is lined while in the mold with a liner film that enhances the sealing and barrier properties of the inner surface of the cap, thus eliminating the need of a secondary process after molding to insert a seal element to the inside of the cap. In addition, the lining film may also be decorated with graphics as described above so that the consumer is presented with the graphic on the inside of the soft drink cap when the cap is removed from the bottle.

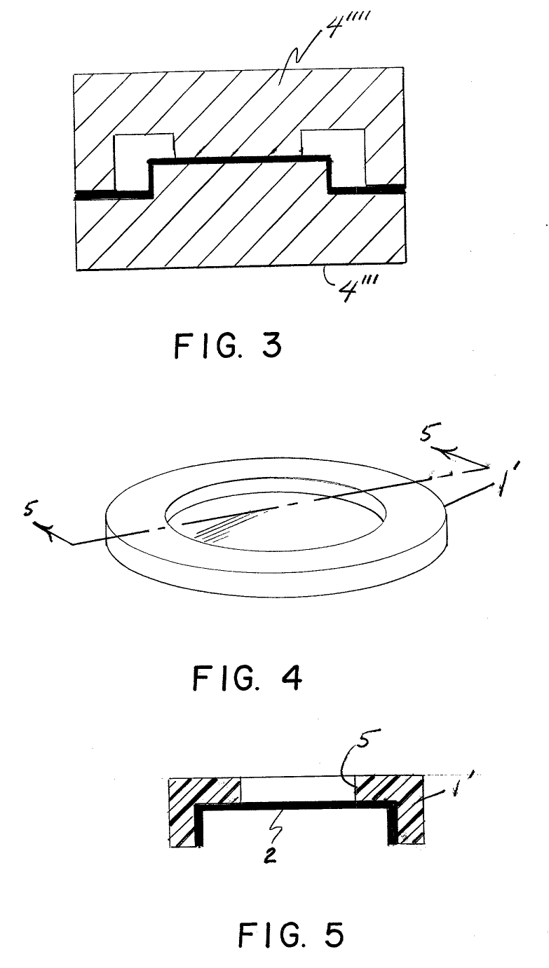

As another example, as shown in FIGS. 3-5, the surface lining system of the present invention may be used to produce a closed transparent viewing area or window 5 in a molded plastic part 1. The lining material 2 in the window area may also be partially decorated with graphics as described above. The use of a transparent viewing area or window is typical in various packaging environments such as packages for ice cream.

With reference to FIGS. 1-2, the method of lining the molded plastic cup discussed above involves the opening of an injection mold cavity the placement of an appropriate web of film 2 between the male portion of the mold and the female portion of the mold, thereafter closing the mold, thereafter injecting recycled polyethylene 3 in a molten form into the mold surrounding the male portion of the mold. Thereafter, the thermoplastic polyethylene would be permitted to cool and would subsequently be ejected from the mold. According to this method, the exterior of the cup 1 may also be covered by the same or another pre-engineered film so as to provide special chemical or decorational characteristic to the outside of the thermoplastic molded cup. In this instance, after the mold is opened, a first web of engineered covering would be inserted into the interior of the male portion of the mold and held against the wall thereof prior to the insertion of the female portion of the mold along with the pre-engineered film tightly covering the exterior of the male portion of the mold. Thereafter, the recycled polyethylene is injection molded into the space formed between the pre-engineered films and the product then ejected. In this way, a three layer product in cross section can be created of different materials having different characteristic all in a single injection molding step.

As a further example, we have tested a stretch film for the purpose of evaluating the surface lining system according to the present invention. The results for the maximum load (PSI) and elongation (%) are presented below in tabular form along with a comparison of data for other types of film taken from Plastics Technology's Manufacturers' Handbook and Buyers' Guide (1993-1994).

It should be noted that the comparison and values are often stated as a range which accommodates values for different resins under the same category. Average values for the range are in parenthesis:

| Film Properties | Peak Load (psi) | | Elongation (%) | |
|---|---|---|---|---|
| Experimental Film | | | | |
| Machine Direction | 3.8 | | 480 | |
| Cross Machine Direction | 3.7 | | 570 | |
| LDPE Blown | 1.5-4.3 | (2.9) | 200-575 | (388) |
| LDPE Extruded | 1.4-4 | (2.7) | 250-760 | (505) |
| LLDPE Blown | 1.43-5.9 | (3.7) | 380 | |
| LLDPE Extruded | 1.3-5.65 | (3.5) | 520-880 | (700) |

It was found that the ultra low density film of the present invention has a similar behavior in both the machine and cross-machine direction thus indicating that it is useful in those situations where uniform elongation in all directions is desirable. Data was not available for both the machine and cross-machine directions for the other films since this is not a common characteristic in the plastic films referenced above.

Although the present invention has been described with preferred embodiments, it is to be understood that modifications and variations may be resorted to without departing from the spirit and scope of this invention as those skilled in the art would readily understand. Such variations and modifications are considered to be within the purview and scope of the appended claims.

What is claimed:

1. A plastic part having a desired surface covering including an object made out of thermoplastic material covered by a layer of film stretched during the molding of the plastic part to conform intimately to the exact desired exterior of the molded part, said exterior layer comprising an ultra low density polyethylene film of about 0.5 to 5 mils in thickness and having substantially uniform elongation in both directions and in substantially the same proportion.

2. The invention of claim 1 wherein the plastic part is made of recycled polyethylene and the covering is of a virgin ultra low density polyethylene whereby the part is useful for contact with food or other items that might be contaminated by the recycled high density polyethylene.

3. A container comprising a body and a cap, said cap comprising a high density polyethylene base lined with an ultra low density polyethylene web, said base and web being formed by the simultaneous injection molding of said cap while using said web to cover one wall of the injection mold.

4. The invention of claim 3 wherein said lining web has indicia thereon which are printed prior to a combination of the web and the cap base during the injection molding process.

5. The method of surface lining a plastic part including, the steps of:
a. providing an injection molding cavity of the appropriate shape for the desired plastic part;
b. providing a thermoplastic web of ultra low density polyethylene film located between the male and female portions of said mold;
c. closing said mold while conforming said thermoplastic film to at least part of the exterior of the male mold;
d. adding plastic material into the remainder of the mold cavity;
e. allowing the added plastic material to cool sufficiently; and
f. ejecting the plastic part with the film surface adjacent thereto.

6. The method of surface lining a thermoplastic part comprising
a. providing a mold cavity formed by relatively movable male and female mold parts;
b. opening the mold;
c. placing a web of liner film of ultra low density polyethylene between the mold parts, said film being characterized by the fact that it elongates in a uniform fashion in all directions and in relatively the same proportions;
d. closing the mold to form the mold cavity with said liner film therein;
e. injecting molten thermoplastic material into said cavity on one side of said liner to fill the same and simultaneously force said liner against the wall of the mold cavity;
f. holding said mold for enough time for said thermoplastic part and liner to cool;
g. ejecting said liner-covered thermoplastic part from the mold.

7. The invention of claim 6 wherein said film contains indicia.

8. The invention of claim 6 wherein said film contains decoration.

9. The invention of claim 6 wherein said film comprises PVDC.

10. The invention of claim 6 wherein said film comprises EVOH.

11. The invention of claim 6 wherein said part is molded to define an opening over which said liner is adhered, and said liner is transparent to form a window in said opening.

12. The invention of claim 6 wherein said web comprises an adhesive layer between said polyethylene film and a second film.

13. The invention of claim 6 wherein said thermoplastic part and liner film bond together.

14. The invention of claim 6 wherein said film covers only a portion of said thermoplastic part.
